(19) United States
(12) Patent Application Publication
(10) Pub. No.: US 2023/0397601 A1
(43) Pub. Date: Dec. 14, 2023

(54) Duck Decoy Device

(71) Applicant: Brandon Boyd, Irvine, CA (US)

(72) Inventor: Brandon Boyd, Irvine, CA (US)

(21) Appl. No.: 18/173,120

(22) Filed: Feb. 23, 2023

Related U.S. Application Data
(60) Provisional application No. 63/350,898, filed on Jun. 10, 2022.

(51) Int. Cl. A01M 31/06

(52) U.S. Cl. CPC A01M 31/06

(57) ABSTRACT

The present invention relates to a duck decoy device comprised of a duck body with a housing, comprised of at least one vibration motor and at least one spool that houses at least one line. The line can be pulled from the housing and placed in a body of water with a weight attached to prevent the device from moving while floating. The line can be locked at a desired length and then retracted into the housing when not in use to prevent tangling of the line. In addition, the vibration motor vibrates the water near the device to give the illusion of a duck moving on the water.

### CROSS-REFERENCE TO RELATED APPLICATION

The present application claims priority to, and the benefit of, U.S. Provisional Application No. 63/350,898, which was filed on Jun. 10, 2022, and is incorporated herein by reference in its entirety.

### FIELD OF THE INVENTION

The present invention relates generally to the field of duck decoys. More specifically, the present invention relates to a duck decoy device comprised of a duck body with a housing, comprised of at least one vibration motor and at least one spool that houses at least one line. The line can be pulled from the housing and placed in a body of water with a weight attached to prevent the device from moving while floating. The line can be locked at a desired length and then retracted into the housing when not in use to prevent tangling of the line. In addition, the vibration motor vibrates the water near the device to give the illusion of a duck moving on the water. Accordingly, the present disclosure makes specific reference thereto. Nonetheless, it is to be appreciated that aspects of the present invention are also equally applicable to other like applications, devices, and methods of manufacture.

### BACKGROUND

Floating duck decoys are often used by duck hunters while duck hunting. However, lines for duck decoys can often become tangled and unorganized before, after, and during a hunt. In addition, duck decoys must be prepared before going on a hunt, which takes considerable time and effort. In addition, existing duck decoys known in the art cannot accurately mimic the movement of a duck in the surrounding water. This can negatively affect a hunter's ability to attract ducks using existing duck decoys.

Therefore, there exists a long-felt need in the art for an improved duck decoy. There also exists a long-felt need in the art for a duck decoy weight device that allows a user to easily manage the weight line of a duck decoy. In addition, there exists a long-felt need in the art for a duck decoy device that allows a user to easily add weight to a duck decoy. Further, there exists a long-felt need in the art for a duck decoy device that more accurately mimics the movement of a duck in the surrounding water.

The subject matter disclosed and claimed herein, in one embodiment thereof, comprises a duck decoy device. The device is comprised of a duck body with a housing comprised of at least one vibration motor and at least one spool that houses at least one line. The line can be pulled from the housing and placed in a body of water with a weight attached to prevent the device from moving while floating. The line can be locked at a desired length and then retracted into the housing when not in use to prevent tangling of the line. In addition, the vibration motor vibrates the water near the device to give the illusion of a duck moving on the water. The housing is also comprised of at least one opening that allows a plurality of the devices to be easily attached to one another during storage, transport, and/or use.

In this manner, the duck decoy device of the present invention accomplishes all of the foregoing objectives and provides an improved duck decoy that allows a user to easily manage the weight line of a duck decoy. In addition, the device allows a user to easily add weight to a duck decoy. Further, the vibration motor of the device more closely mimics the movement of a duck on the surrounding water, thereby increasing a hunter's chance of successfully hunting ducks using the device.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a duck decoy device. The device is comprised of a duck body with a housing comprised of at least one vibration motor and at least one spool that houses at least one line. The device is comprised of a duck body that may resemble any breed and gender of duck and/or waterfowl. At least one housing is preferably attached to a bottom surface of the body. The housing is preferably comprised of at least one opening in the side wall of the housing that allows the device to be easily clipped or attached to a rope or other device for transport, storage, and/or use.

At least one spool is housed within the body, wherein the spool can rotate 360 degrees around at least one axle within the body. In the preferred embodiment, the spool is a spring-loaded spool with at least one coil spring. At least one line can be stored around and pulled from the spool. In the preferred embodiment, the line is a nylon braided fishing line.

To use the device, a user can pull the line from at least one opening on the bottom wall of the housing. Once pulled to the desired length, the length of the line can be locked using at least one locking mechanism that may either stop the rotation of the spool and/or prevent more line from exiting the opening. After the line has been locked at a desired length and is done being used, the line can automatically be retracted into the body by disabling the locking mechanism using at least one retract button (or in one embodiment, pressing the locking mechanism again). The button disengages the locking mechanism such that the force of the spring-loaded spool (which is in constant tension when the line is locked at the desired length) automatically winds the line back around the spool.

The line is also comprised of at least one fastener that allows at least one weight to attach to the line. The weight prevents the device from floating to an undesired location while the device is being used in a body of water by sinking to the bottom of the body of water.

In one embodiment, the device is comprised of at least one vibrating motor with at least one, but preferably a plurality of vibration levels. The motor can be turned on/off and/or the vibration level can be selected using a button on the housing. In this manner, the motor vibrates the water around the device, thus giving the illusion of movement (as a real duck would create) on the surface of the water.

Accordingly, the duck decoy device of the present invention is particularly advantageous as it provides an improved duck decoy. More specifically, the device allows a user to easily manage the weight line of a duck decoy and also allows a user to easily add weight to a duck decoy. Further, the device more accurately mimics the movement of a duck in the surrounding water. In this manner, the duck decoy device overcomes the limitations of existing duck decoys known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of a duck decoy device of the present invention while floating in a body of water in accordance with the disclosed architecture;

FIG. 2 illustrates a side view of a spool of one potential embodiment of a duck decoy device of the present invention in accordance with the disclosed architecture;

FIG. 3 illustrates a perspective view of a line of one potential embodiment of a duck decoy device of the present invention in accordance with the disclosed architecture;

FIG. 4 illustrates a side view of a battery of one potential embodiment of a duck decoy device of the present invention in accordance with the disclosed architecture; and

FIG. 5 illustrates a flowchart of a method of using one potential embodiment of a duck decoy device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved duck decoy. There also exists a long-felt need in the art for a duck decoy weight device that allows a user to easily manage the weight line of a duck decoy. In addition, there exists a long-felt need in the art for a duck decoy device that allows a user to easily add weight to a duck decoy. Further, there exists a long-felt need in the art for a duck decoy device that more accurately mimics the movement of a duck in the surrounding water.

The present invention, in one exemplary embodiment, is comprised of a duck decoy device, comprised of a duck body with a housing comprised of at least one vibration motor and at least one spool that houses at least one line. The device is comprised of a duck body that may resemble any breed and gender of duck and/or waterfowl. At least one housing is preferably attached to a bottom surface of the body, wherein the housing is preferably comprised of at least one opening in the side wall of the housing that allows the device to be easily clipped or attached to a rope or other device for transport, storage, and/or use.

At least one spool is housed within the body. The spool can rotate 360 degrees around at least one axle within the body. In the preferred embodiment, the spool is a spring-loaded spool with at least one coil spring. At least one line can be stored around and pulled from the spool, wherein the line is preferably a nylon braided fishing line.

To use the device, a user can pull the line from at least one opening on the bottom wall of the housing to a desired length. The line can then be locked using at least one locking mechanism that may either stop the rotation of the spool and/or prevent more line from exiting the opening. After the line has been locked at the desired length and is done being used, the line can automatically be retracted into the body by disabling the locking mechanism using at least one retract button (or in one embodiment, pressing the locking mechanism again). The button disengages the locking mechanism such that the force of the spring-loaded spool (which is in constant tension when the line is locked at the desired length) automatically winds the line back around the spool.

The line is also comprised of at least one fastener that allows at least one weight to attach to the line. The weight prevents the device from floating to an undesired location while the device is being used in a body of water by sinking to the bottom of the body of water.

The device may also be comprised of at least one vibrating motor with at least one, but preferably a plurality of vibration levels. The motor can be turned on/off and/or the vibration level can be selected using a button on the housing. In this manner, the motor vibrates the water around the device, thus giving the illusion of movement (as a real duck would create) on the surface of the water.

Accordingly, the duck decoy device of the present invention is particularly advantageous as it provides an improved duck decoy. More specifically, the device allows a user to easily manage the weight line of a duck decoy and also allows a user to easily add weight to a duck decoy. Further, the device more accurately mimics the movement of a duck in the surrounding water. In this manner, the duck decoy device overcomes the limitations of existing duck decoys known in the art.

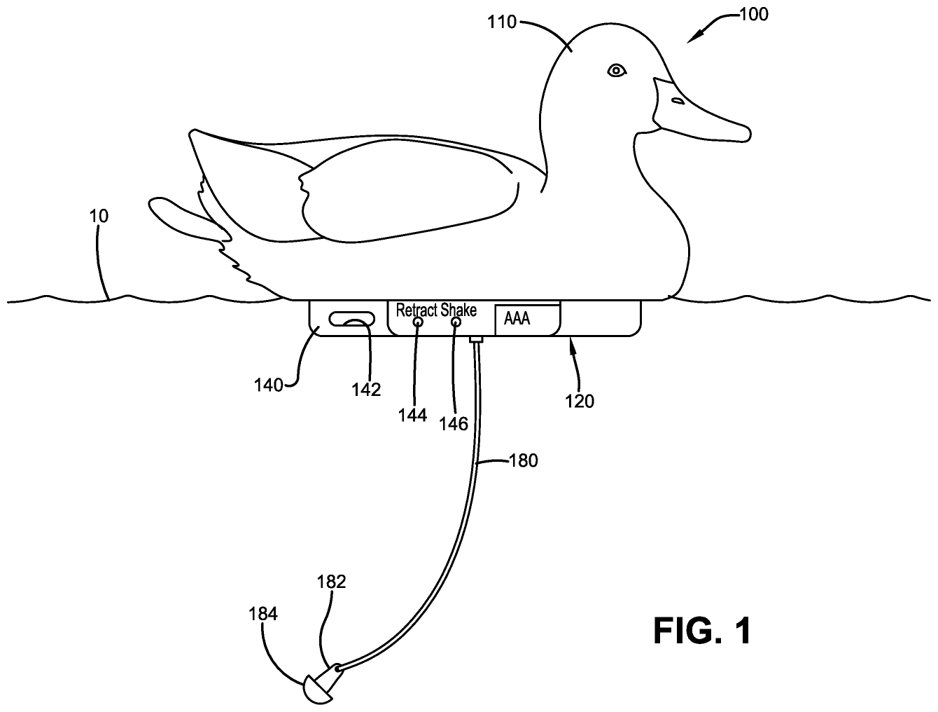

Referring initially to the drawings, FIG. 1 illustrates a side view of one potential embodiment of a duck decoy device 100 of the present invention while floating in a body of water 10 in accordance with the disclosed architecture. The device 100 is comprised of a duck body 110 with a housing 120, comprised of at least one vibration motor 160 and at least one spool 170 that houses at least one line 180. Unless specified herein, all components of the device 100 are comprised of a rigid, waterproof, and UV-resistant plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. Further, the duck body 110 may resemble any breed and gender of duck and/or waterfowl that are known such as, but not limited to, dabbling ducks, diving ducks, geese, or other waterfowl. The body 110 is preferably hollow such that it is buoyant.

At least one housing 120 is preferably attached to a bottom surface 112 of the body 110. In one embodiment, the housing 120 is fixedly attached to the body 110. In another embodiment, the housing 120 is removably attached to the bottom surface 112 using at least one set of reciprocating fasteners 114. The fasteners 114 may be any type known in the art such as, but not limited to, snap fasteners, hook and loop, clips, magnets, etc. In this embodiment, the housing 120 is removable from the body 110 for maintenance/cleaning.

The housing 120 is preferably comprised of at least one opening 142 in the side wall 140 of the housing 120. This allows the device 100 to be easily clipped or attached to a rope or other device for transport, storage, and/or use. For example, in one embodiment, multiple devices 100 can be tied together for transport, storage, and/or use using a singular rope. The body 110 may also be comprised of at least one similar opening for the same purpose.

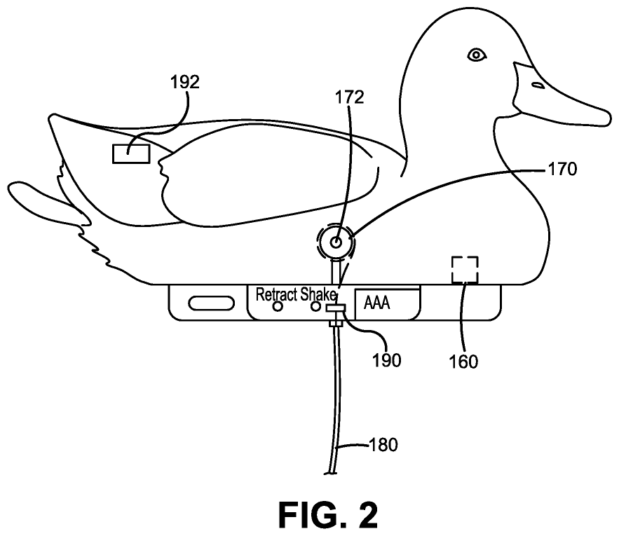

FIG. 2 illustrates a side view of a spool 170 of one potential embodiment of a duck decoy device 100 of the present invention in accordance with the disclosed architecture. At least one spool 170 is housed within the body 110. The spool 170 can rotate 360 degrees around at least one axle 172 within the body 110. In the preferred embodiment, the spool 170 is a spring-loaded spool with at least one coil spring. At least one line 180 can be stored around and pulled from the spool 170. In the preferred embodiment, the line 180 is a nylon braided fishing line. However, the line 180 may be any rope or line type known in the art.

To use the device 100, a user can pull the line 180 from at least one opening 132 on the bottom wall 130 of the housing 120. Once pulled to the desired length, the length of the line 180 can be locked using at least one locking mechanism 190 that may either stop the rotation of the spool 170 and/or prevent more line 180 from exiting the opening 132. In various embodiments, the mechanism 190 may be in the form of a locking button or other locking mechanism known in the art such as, but not limited to, a brake, a clasp, etc. In one embodiment, the line 180 is fixedly attached (i.e., integrally formed to) to the spool 170. In another embodiment, the line 180 is removably attached (i.e., wrapped around) to the spool 170 for cleaning/replacement purposes.

After the line 180 has been locked at a desired length and is done being used, the line 180 can automatically be retracted into the body 110 by disabling the locking mechanism 190 using at least one retract button 144 (or in one embodiment, pressing the locking mechanism 190 again). The button 144 disengages the locking mechanism such that the force of the spring-loaded spool 170 (which is in constant tension when the line 180 is locked at the desired length) automatically winds the line 180 back around the spool 170. The line 180 may be any length but is preferably 20 feet in length.

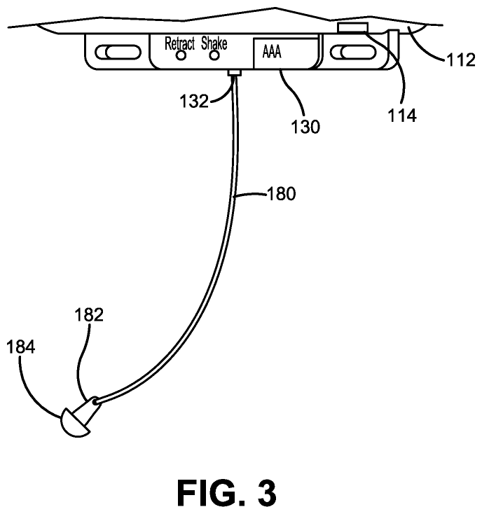

FIG. 3 illustrates a perspective view of a line 180 of one potential embodiment of a duck decoy device 100 of the present invention in accordance with the disclosed architecture. The line 180 is also comprised of at least one fastener 182 that allows at least one weight 184 to attach to the line 180. The weight 184 may be any style, size, and mass of weight and/or fishing weight known in the art. The weight 184 prevents the device 100 from floating to an undesired location while the device 100 is being used in a body of water by sinking to the bottom of the body of water. The fastener 182 is preferably a snap-swivel fastener but may be any fastener such as, but not limited to, a clip, a latch, a tie, a magnet, etc.

In one embodiment, the device 100 is comprised of at least one vibrating motor 160. The motor can be turned on using at least one vibration button 146. The motor 160 has at least one, but preferably a plurality of vibration levels, that can be turned on/off and/or selected using the button 146. In this manner, the motor 160 vibrates the water around the device 100, thus giving the illusion of movement (as a real duck would create) on the surface of the water. In differing embodiments, the motor 160 may have a plurality of cycle lengths, such as, but not limited to, every other minute, wherein the motor 160 vibrates and then ceases to vibrate in an intermittent fashion. Additionally, or alternatively, the motor 160 can continuously vibrate after the button 146 is pressed.

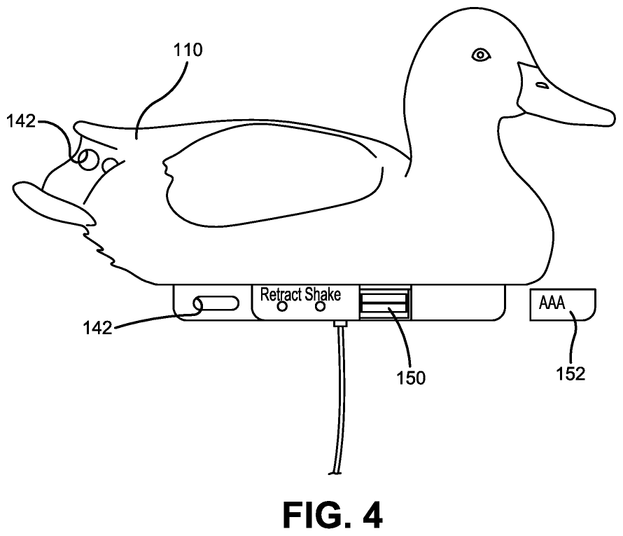

FIG. 4 illustrates a side view of a battery 150 of one potential embodiment of a duck decoy device 100 of the present invention in accordance with the disclosed architecture. The motor 160 is powered by at least one battery 150. The battery 150 may be a disposable battery 150 or a rechargeable battery 150 in the form of an alkaline, nickel-cadmium, nickel-metal hydride battery 150, etc., such as any 3V-12 volts DC battery 150 or other conventional battery 150 such as A, AA, AAA, etc., that supplies power to the device 100. Throughout this specification, the terms “battery” and “batteries” may be used interchangeably to refer to one or more wet or dry cells or batteries 150 of cells in which chemical energy is converted into electricity and used as a source of DC power. References to recharging or replacing batteries 150 may refer to recharging or replacing individual cells, individual batteries 150 of cells, or a package of multiple battery cells as is appropriate for any given battery 150 technology that may be used. The battery 150 can be accessed via at least one waterproof battery door 152. In one embodiment, the battery 150 is charged by at least one solar panel 192 of any type known in the art, wherein the solar panel 192 is positioned on the body 110.

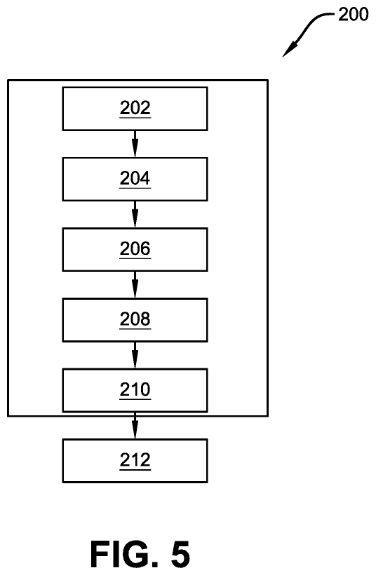

FIG. 5 illustrates a flowchart of a method 200 of using one potential embodiment of a duck decoy device 100 of the present invention in accordance with the disclosed architecture. The device 100 is also comprised of a method 200 of using the device 100. First, the line 180 is pulled from the housing 120 until it reaches a desired length [Step 202]. Then, the locking mechanism 190 can be engaged to lock the line 180 at said desired length [Step 204]. Then, a weight 184 can be attached to the line 180 using at least one fastener 182 [Step 206]. Next, the device 100 can be placed in a body of water 10 [Step 208]. Then, the vibration motor 160 can be activated via the button 146 [Step 210]. When finished being used, the line 180 can be retracted into the housing 120 around the spool 170 by pressing the retract button 144 which disengages the locking mechanism 190 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “duck decoy device” and “device” are interchangeable and refer to the duck decoy device 100 of the present invention.

Notwithstanding the foregoing, the duck decoy device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the duck decoy device 100 as shown in the FIGS. are for illustrative purposes only, and that many other sizes and shapes of the duck decoy device 100 are well within the scope of the present disclosure. Although the dimensions of the duck decoy device 100 are important design parameters for user convenience, the duck decoy device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A duck decoy device comprising:
a body;
a housing attached to the body;
an opening in the housing;
a spool positioned within the body;
a line comprised of a fastener;
a motor;
a battery; and
a locking mechanism.

2. The duck decoy device of claim 1, wherein the body is comprised of a buoyant material.

3. The duck decoy device of claim 1, wherein the body resembles a duck or a waterfowl.

4. The duck decoy device of claim 1, wherein the line attaches to the spool.

5. The duck decoy device of claim 1, wherein the locking mechanism is comprised of a button.

6. A duck decoy device comprising:
a body that resembles a duck or a waterfowl, wherein the body is hollow;
a housing comprised of a first opening and a second opening;
a spool positioned within the body;
a line comprised of a fastener;
a motor;
a battery; and
a locking mechanism.

7. The duck decoy device of claim 6, wherein the spool is a spring-loaded spool.

8. The duck decoy device of claim 6, wherein the body is comprised of a waterproof material.

9. The duck decoy device of claim 6, wherein the housing is removably attached to a bottom surface of the body via a body fastener.

10. The duck decoy device of claim 6, wherein the line is comprised of a nylon-braided fishing line.

11. The duck decoy device of claim 6, wherein the spool rotates 360 degrees around an axle.

12. The duck decoy device of claim 6, wherein the locking mechanism locks the line at a desired length.

13. The duck decoy device of claim 12, wherein the retract button disengages the locking mechanism.

14. The duck decoy device of claim 6, wherein the fastener of the line is a snap-swivel fastener.

15. The duck decoy device of claim 6, wherein the motor causes a vibration.

16. The duck decoy device of claim 15, wherein a vibration button engages the vibration of the motor.

17. The duck decoy device of claim 16, wherein the motor is comprised of a first vibration level and a second vibration level.

18. The duck decoy device of claim 16, wherein the motor has a vibration cycle.

19. The duck decoy device of claim 6, wherein the battery is charged via a solar panel.

20. A method of using a duck decoy device, the method comprising the steps of:
pulling a line from a housing of the duck decoy device until the line reaches a desired length;
engaging a locking mechanism of the duck decoy device to lock the line at the desired length;
adding a weight to the line using a fastener of the line;
placing the duck decoy device in a body of water;
activating a vibration motor of the duck decoy device; and
retracting the line back into the housing by pressing a retract button which disengages the locking mechanism.
